(19) United States
(12) Patent Application Publication
(10) Pub. No.: US 2007/0023948 A1
(43) Pub. Date: Feb. 1, 2007

(54) Mould for making a ceramic product

(75) Inventor: Giorgio Sarani, Bologna (IT)

Correspondence Address: SQUIRE, SANDERS & DEMPSEY L.L.P., 14TH FLOOR, 8000 TOWERS CRESCENT, TYSONS CORNER, VA, 22182, US

(73) Assignee: SACMI COOPERATIVA MECCANICI IMOLA SOCIETA COOPERATIVA

(21) Appl. No.: 11/489,509

(22) Filed: Jul. 20, 2006

(30) Foreign Application Priority Data
Jul. 29, 2005 (IT) BO2005A000514

(51) Int. Cl. B28B 1/26; B29C 44/36; B29C 45/17

(52) U.S. Cl. 264/86; 425/555; 425/547

(57) ABSTRACT

A porous mould for making sanitaryware comprises: two half-parts (2, 3) joined to each other to create a product forming cavity (4); one of the half-parts (2) has a first inlet opening (5) through which respective means (6) feed a liquid (7) under pressure into the product forming cavity (4); a variable volume element (8) located inside the cavity (4); second means (10) for feeding a fluid under pressure, acting on this element (8) and varying the volume of the element (8) between at least two limit states, namely, a least expanded, idle state and a most expanded working state, when the forming liquid (7) is fed in, and where the element (8) occupies a predetermined volume of the cavity (4) in such a way as to control the inflow of the liquid (7) along the surfaces of the cavity (4); means (11) for controlling and regulating the degree to which the element (8) is filled and the liquid (7) feed pressure, acting on the respective first feed means (6) and second feed means (10) in such a way as to correlate the feed pressures according to the extent to which the cavity (4) has been filled by the liquid (7).

### BACKGROUND OF THE INVENTION

This invention relates to a mould for making a ceramic product.

As is well known in this trade, ceramic products (in this specification, we refer to sanitaryware such as washbasins, toilet bowls, bidets and the like but without restricting the scope of the invention) are made by pressure casting a liquid mixture, known as slip, consisting of water, clay and very small quantities of other substances, in “shell” moulds made of porous resin.

The mould gives the article of sanitaryware the required shape and after a certain length of time (necessary to draw out the water) the article is extracted from the mould in a solid form and further processed according to a well-known sequence of steps until it is completely finished.

Sanitaryware made in this way can be broadly divided into two main categories, namely: “solid cast” products and “liquid cast” products, as they are known in the jargon of the trade.

The first category of products (solid cast), typical examples of which are lidded cisterns, are thus defined because the male and female parts of the mould have, along their normals, regular surfaces which are spaced from each other usually less than twice the thickness formed by one part of the mould. In other words, the main feature of solid cast products is that their walls are formed by two mould parts (a male and a female part) which are spaced from each other less than twice the thickness of each part of the mould.

Besides this, in cross section, the cistern lid is greater than or equal to the thickness of the tank.

The second category of sanitaryware, that is, liquid cast sanitaryware (of particular relevance to this invention) allows maximum freedom of form for the cistern and lids (referring again to this type of product). The mould may have different dimensional ratios within it and the casting cavities may be very large.

In this case, the casting cavity is not divided between a male and a female part, as in the previous case, but the walls of the product are formed by a single surface within the mould.

This category includes, for example, washbasin pedestals (which can be geometrically likened to large tubes of any thickness).

A well-known and major drawback in the production of sanitaryware of this second category is known in the jargon of the trade as “coagulation” or “flocculation” or growth line where the slip does not solidify uniformly against the walls of the mould leading, as we will see, to serious defects that make the quality of the end product unacceptable.

The problem occurs inside the mould when the slip is fed in under pressure (usually from the bottom) and gradually “grows” inside the mould, its level rising until it completely fills the cavity.

The actual causes of the problem are still not clear although laboratory tests have indicated the following as the principal factors involved: the large volume of the mould, the relative internal air volume and the force of gravity.

Whatever the causes, the fact remains that, as the mould fills, the different substances in the slip tend to “separate out” in random fashion: that is because the slip is not a perfectly homogeneous mixture but is basically a suspension, in water, of clay and other substances with different specific weights which, as the level of the slip increases, leads to the separation between the substances of lower specific weight (tending to rise to the surface) and those of higher specific weight (tending to sink).

The separation process as the mould fills may lead to thickening or agglomeration of like substances separated from the different substances surrounding them.

The result of the agglomeration is the presence, on the surface of the rising slip, of a sort of colored “stain” indicating the non-homogeneousness of the mixture: if this stain comes into contact with the surface of the mould, the product develops a flaw at that point.

The flaw, however, only becomes visible after the product is fired or finally glazed and appears as a clearly visible surface defect (for example in the form of a hump or recess) making it necessary to reject the product.

The aim of this invention is to overcome the above mentioned drawback by providing a mould for making a ceramic product, in particular a liquid cast product, structured in such a way as to prevent, during the step of filling the slip into the mould, the formation of agglomerations inside the resin mould leading to defects in the finished ceramic product.

### SUMMARY OF THE INVENTION

In accordance with the invention, this aim is achieved by a porous mould for making a ceramic product, the mould comprising: two half-parts joined to each other to create a product forming cavity; one of the half-parts has a first inlet opening through which respective means feed a liquid under pressure into the product forming cavity; a variable volume element located inside the cavity; second means for feeding a fluid under pressure, acting on this element and varying the volume of the element between at least two limit states, namely, a least expanded, idle state and a most expanded working state, when the forming liquid is fed in, and where the element occupies a predetermined volume of the cavity in such a way as to control the inflow of liquid along the surfaces of the cavity; means for controlling and regulating the degree to which the element is filled and the liquid feed pressure, acting on the respective first and second feed means in such a way as to correlate the feed pressures according to the extent to which the cavity has been filled by the liquid.

### BRIEF DESCRIPTION OF THE DRAWINGS

The technical characteristics of the invention, with reference to the above aims, are clearly described in the claims below and its advantages are apparent from the detailed description which follows, with reference to the accompanying drawings which illustrate a preferred embodiment of the invention provided merely by way of example without restricting the scope of the inventive concept, and in which:

FIGS. 1 and 2 are, respectively, schematic front and side views, with some parts in cross section and others cut away to better illustrate others, of a first mould according to the present invention for making a ceramic product;

FIGS. 3 and 4 are, respectively, schematic front and side views, with some parts in cross section and others cut away to better illustrate others, of a second mould according to the present invention for making ceramic sanitaryware;

FIGS. 5 and 6 are, respectively, schematic front and side views, with some parts in cross section and others cut away to better illustrate others, of a first mould according to the present invention for making ceramic sanitaryware;

FIG. 7 is a scaled-up side view, with some parts cut away and others in cross section, of a detail A from FIG. 5, showing an expandable element in an idle state inside the mould;

FIGS. 8 to 12 are schematic side views illustrating respective steps in the manufacture of a ceramic product using the mould illustrated in the drawings listed above.

### DESCRIPTION OF THE PREFERRED EMBODIMENTS

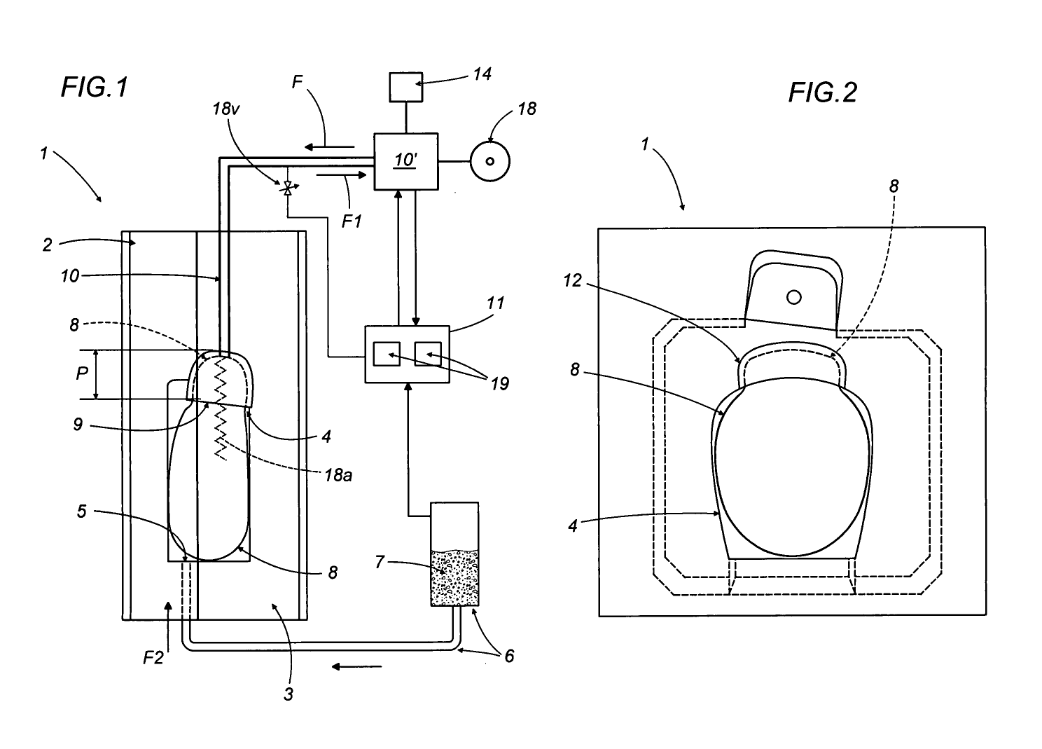

With reference to the accompanying drawings, in particular FIGS. 1 to 6, the mould according to the invention, denoted in its entirety by the numeral 1, is used to make ceramic products and the like, for example, sanitaryware such as washbasins, toilet bowls, bidets, and accessories for the same, to which we mainly refer but without restricting the scope of the invention, since the mould might be used to make tableware or other ceramic articles.

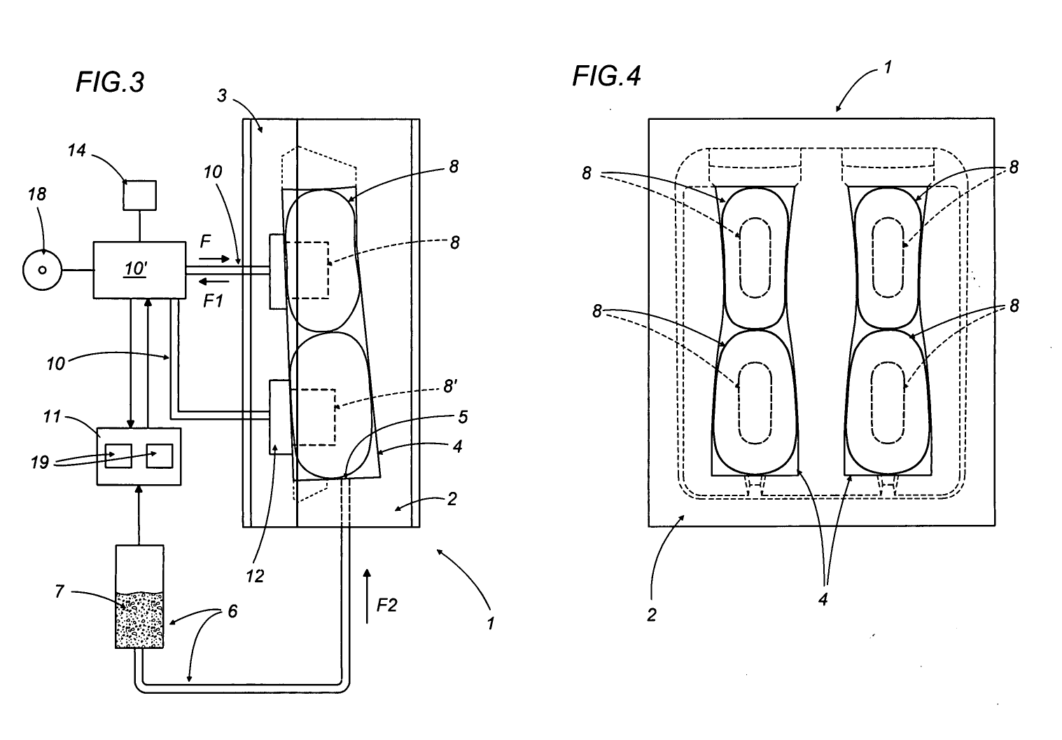

In the embodiment illustrated, these products are, purely by way of example and without restricting the scope of the invention, those known as “liquid cast” products, that is, products allowing the maximum freedom of form (for example, cisterns, cistern lids and toilet bowls—see FIGS. 1, 2 and 5, 6—or washbasin pedestals—see FIGS. 3 and 4) and thus cast in high-volume casting cavities.

The mould according to the invention, for example of porous resin, consists of two half-parts 2, 3 joined to each other to create a product forming cavity 4.

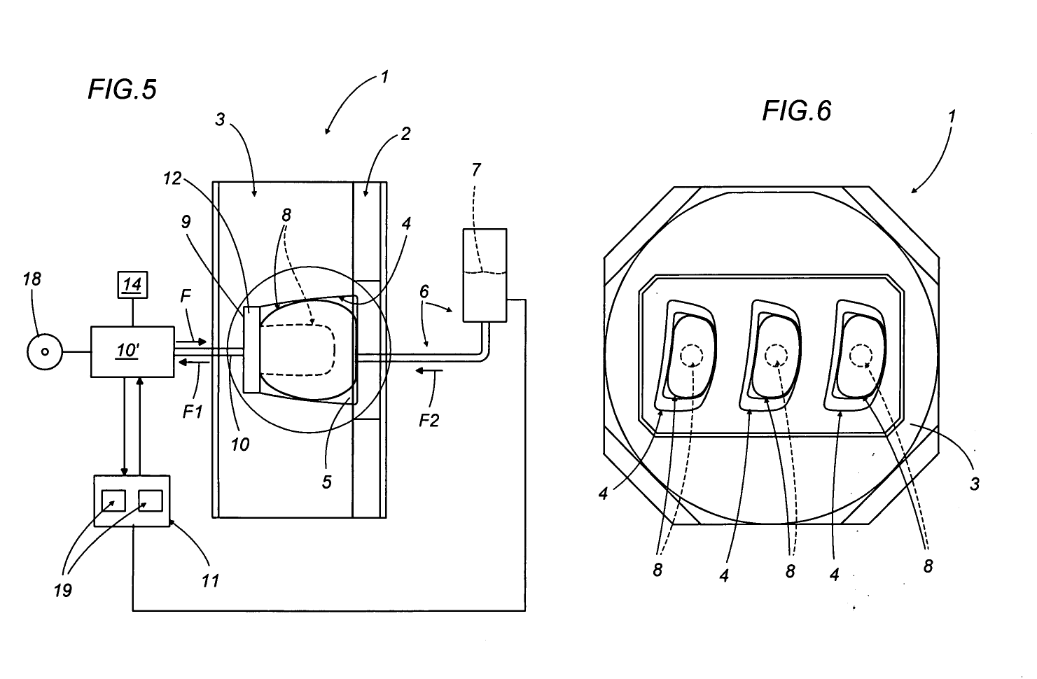

Obviously, depending on the type of mould 1, there may be two or more cavities 4 in the same mould 1 (two in the example illustrated in FIGS. 3 and 4, or three in the example illustrated in FIGS. 5 and 6) without thereby restricting the scope of the inventive concept.

One of the two half-parts 2 has a first inlet opening 5 through which respective means 6 (of known type and thus illustrated schematically) feed a liquid 7 (known as slip and consisting of a suspension of clay and other suitable substances in water) under pressure into the product forming cavity 4 which is completely closed when the two half-parts 2 and 3 are joined.

The mould 1 also comprises:

at least one variable volume element 8 located inside the cavity 4 and connected to, or associated with, an inside surface 9 of one of the half-parts 3;

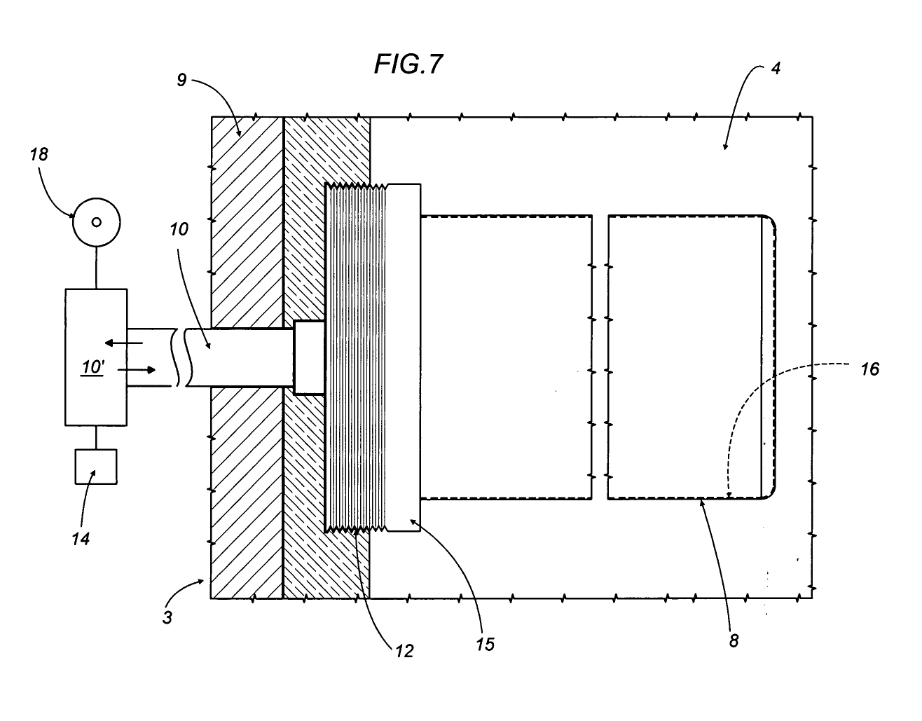

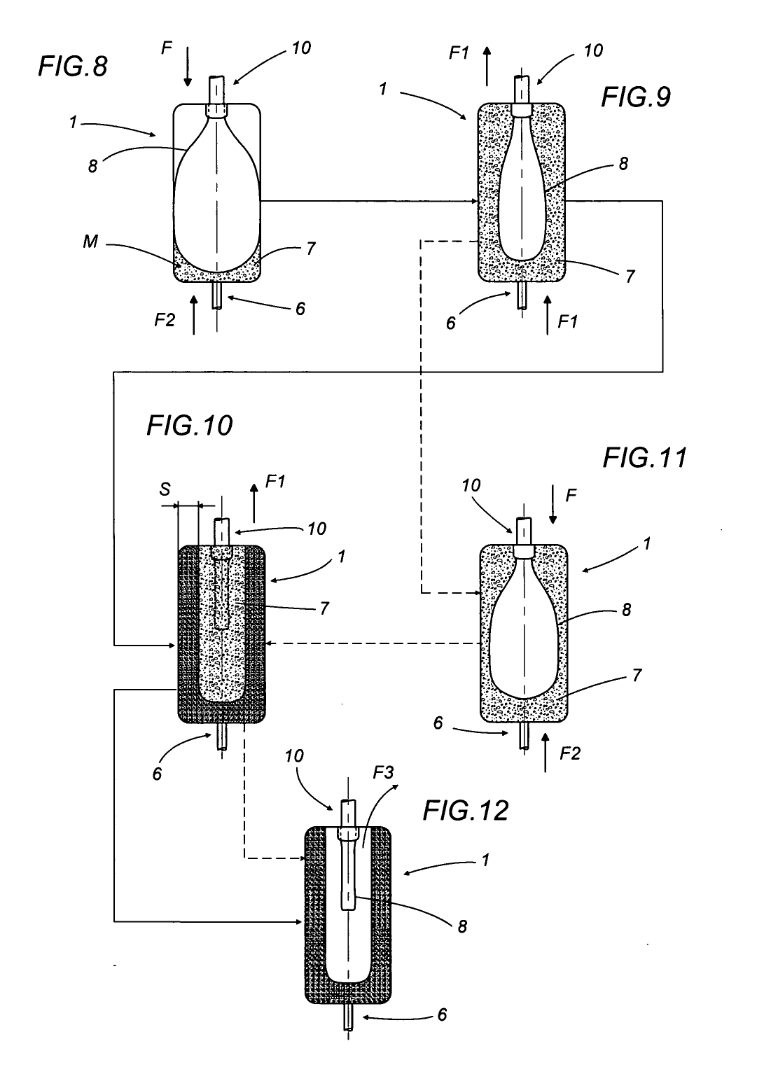

second means 10 for feeding a fluid under pressure, acting on the element 8 and varying the volume of the element 8 between at least two limit states, namely, a least expanded, idle state (shown in FIG. 7 and in dashed line style in FIGS. 1 to 6) and a most expanded working state (shown in solid line style in FIGS. 1 to 6) forming a gap M (see also FIG. 8) between the surfaces of the cavity 4 and the element 8 itself, when the forming liquid 7 is fed in, and where the element 8 occupies a predetermined volume of the cavity 4 in such a way as to control or drive the inflow of the liquid 7 along the surfaces of the cavity 4;

means 11 for controlling and regulating the degree to which the element 8 is filled and the liquid 7 feed quantity/pressure, acting on the respective first feed means 6 and second feed means 10 in such a way as to correlate the feed pressures according to the extent to which the cavity 4 has been filled by the liquid 7.

In other words, the mould 1 contains an element 8 designed to reduce the volume of the cavity 4 at least while the latter is being filled in such a way as to create a sort of forced passage of the liquid, that is, of the slip 7, along the walls of the cavity 4 itself.

The element 8 preferably possesses properties of expandability and elastic deformation.

Hereinafter, the pressure inside the element 8 will be used, by way of example and without restricting the scope of this specification, as the reference unit to measure the extent to which the element itself is filled, but it will be understood that the control means 11 may be set to control other reference quantities such as the volume of the fluid (whether gas or liquid) used to fill the element 8.

As shown in FIGS. 1 to 7, the expandable element 8 is attached to a surface 9 of the half-part 3 defining a neutral or reject area of the end product.

The surface 9 may have a concavity—preferably a curved portion 12—designed to receive at least one end of the expandable element 8.

The half-part 3 of the mould 1 in which the expandable element 8 is equipped with a through duct 10 (defining the second feed means) for feeding a fluid under pressure from outside the mould 1 and is connected, at one end, to the expandable element 8 and, at the other end, to fluid supply means 10′ (of customary type schematically illustrated as a block, such as, for example, a compressor).

The fluid supply means 10′ may comprise means 14 for reversing the fluid flow in such a way as to enable the fluid to be either filled into the element 8 (see arrow F) or sucked out of the element 8 (see arrow F1).

At a constructional level, the expandable element 8 may consist of a single body of elastically compliant material having a fluid inlet opening associated in a sealed fashion with a support 15 by which it is connected to the surface 9 in which the opening connecting it to the fluid feed duct 10 is made (see FIG. 7).

In an alternative embodiment, the expandable element 8 may consist of an external body of elastically compliant material and an internal body or frame 16 of rigid material (for example of porous resin, drawn in dashed line style in FIG. 7) designed to keep the external body 8 in a matching shape when it is in the least expanded idle state.

The external body 8, too, is equipped at one end with a fluid inlet opening associated in a sealed fashion and in conjunction with the frame 16, with the support 15 by which it is connected to the surface 9.

As illustrated in FIG. 1, the single-body expandable element 8 may be positioned inside a second cavity 17 with an inside depth P such as to accommodate the body 8 in the least expanded state (shown by the broken line) when the fluid supply means 10′ suck the fluid out of it or feed the fluid at a pressure well below the pressure of the liquid 7 in the cavity 4 at that moment in such a way that the pressure of the liquid on the body 8 completely frees the forming cavity 4.

The expandable and elastically compliant element 8 may be made, for example, but without restricting the scope of the invention, of natural elastic rubber (for example India rubber) or of a silicone material).

Although a single expandable element 8 has been described up to now, it will be understood that, depending on the type of mould 1 and on the required shape of the end product, a single forming cavity 4 may have two or more separate elements 8, 8′ placed side by side (as shown in FIGS. 3 and 4).

The above mentioned fluid supply means 10′ are connected to a fluid source 18 controlled by the control means 11 enabling the element 8 to be expanded, in the aforementioned working state, to a pressure at least equal to the pressure at which the liquid 7 is fed into the forming cavity 4.

Preferably, the control means 11 act on the fluid supply means 10′ in such a way that the element 8 is expanded to a pressure at least equal to, and preferably greater than, the pressure at which the liquid 7 is fed into the forming cavity.

Similarly, the control means 11 also act on the fluid supply means 10′ in such a way that, when the forming cavity 4 has been completely filled with the liquid 7, the element 8 changes back to an idle state where the pressure inside it is close to atmospheric pressure and in any case less than the pressure of the liquid 7.

At operating level, the control means 11 may act on the feed means 10′ in such a way as to enable the element 8 to be expanded, in the working condition, to a pressure at least equal to the pressure of the liquid 7 in the forming cavity 4 when the forming cavity 4 is completely full and to the subsequent increased pressure of the liquid 7, thus creating a condition of equal pressure forming an internal elastic surface in contact with the liquid 7 and an auxiliary wall assisting the formation of the thickness S of the ceramic product.

The element 8 might also include means 18a for varying the temperature of the fluid fed into the element 8.

The means 18a (see FIG. 1) might be built into or associated with the frame 16 in such a way as to enable the temperature of the fluid fed into the element 8 to be increased.

The means 18a might, for example, consist of electrical heating elements associated with the frame 16.

By way of example, but without restricting the scope of the invention, the fluid used to expand the element 8 may be gaseous (for example, air) or liquid (for example, water).

As clearly shown in FIGS. 1 to 6, when the expandable element 8 is in the working state, its outside surface may be in contact with the inside surfaces of the forming cavity 4.

For example, the element 8, in its working state, may occupy a volume of between 50% and 100% of the volume of the cavity 4 itself provided that it always forms the above mentioned gap M.

Again by way of example, the element 8, when it is in the idle state or at rest, may be cylindrical in shape (see FIG. 7).

For varying the pressure on the element 8, the control means 11 may comprise a unit 19 for measuring and displaying the reference unit (in the case of pressure, they might be pressure gauges). The unit 19 may be connected to the feed ducts 6 and 10 and/or to the supply means 10′ and turn the fluid flowing through the duct 10 on or off or reverse its direction at least according to the pressure measured and a cavity filling time. The controls may be automatic or manual depending on the working requirements of the casting system.

In practice, therefore, the method for making an article of sanitaryware using the mould 1 described up to now comprises at least the following steps after the two half-parts 2 and 3 of the mould 1 have been closed (see FIGS. 8 to 12):

filling a fluid into the element 8 until reaching the most expanded state of the element 8 itself inside the cavity 4 and at a predetermined pressure, thereby forming the gap M (FIG. 8);

feeding the liquid 7 in controlled manner along the surfaces of the cavity 4 (see arrow F2 also in FIG. 8) at least in the gap M by filling the liquid 7 through the first inlet opening 5 in the half-part 2 at an infeed pressure that is preferably less than the pressure in the element 8.

At this stage, more liquid 7 can be fed into the cavity 4 while simultaneously decreasing the pressure inside the element 8 until it reaches the least expanded state occupying the minimum volume (see FIGS. 9 and 10).

The decrease in the pressure of the element 8 may, as stated above, be controlled by the control means 11 acting on the means 10′ for supplying and discharging the fluid according to the pressure of the liquid 7.

The decrease in the pressure in the element 8 might also be accomplished by simply allowing the fluid to escape through the duct 10 as the pressure in the cavity 4 increases.

Alternatively, the step of filling the gap M might be followed by the following sequence of steps:

a step of feeding more liquid 7 into the cavity 4 and at the same time partially reducing the volume of the element 8 in such a way as to allow a predetermined quantity of liquid 7 to flow into the cavity 4 between the walls of the cavity 4 and the elastic surface of the element 8 (see FIG. 9 again).

At this point, the pressure inside the element 8 might be increased so that the liquid 7 and the element 8 at least reach a condition of equal pressure (see FIG. 11).

For controlling the formation of the ceramic product thickness S, it might be preferable to keep the pressure in the element 8 higher than the pressure of the liquid 7 for a predetermined length of time.

According to the predetermined length of time for forming the product, the above mentioned step is followed by a step of reducing the pressure, and hence also the volume, of the element 8, again for a predetermined length of time, so as to form a more solid product thickness S between the surfaces of the cavity 4 and an internal elastic surface formed by the element 8 and in contact with the liquid 7 (see last step in FIG. 10).

It should be noticed that the step of filling the cavity 4 with more liquid 7 (as is known in the trade) is done at a higher pressure than the initial feed pressure and continues for a predetermined length of time, or with a predetermined quantity of liquid, substantially compensating for the watery part of the liquid that seeps through the porous mould (also on account of the increased pressure) and thus forming the product thickness S (into a substantially solid shape) around the walls of the cavity 4.

All the above mentioned steps of varying pressure and volume are controlled by suitable control means 11 acting on the second means 10′ for supplying and discharging the fluid according to presettable parameters.

For decreasing the pressure, the fluid supply means 10′ preferably include an adjustable relief valve unit 10v (see FIG. 1) connected to the control means 11 for precisely controlling the reduction in pressure in the element 8.

This procedure makes it possible to use the element 8 as an “accompanying” means for forming the product thickness S (that is, it defines a contact wall for the part of the liquid furthest from the mould surfaces) also during the “growing” step, that is, when the pressure of the slip remains higher than the filling pressure.

In other words, the element 8 can be used a sort of “controlled” pressure element achieved through simultaneous use of at least one porous mould wall on one side and at least one variable volume elastic wall on the other.

In other terms, based on the possible procedures obtainable with the element 8, it is possible to continuously form product thickness by controlling the relative correlated pressures between the liquid 7 and the element 8.

Yet another step might be that of varying the temperature of the fluid inside the element 8 using the means 18a.

For example, the temperature of the fluid fed into the element 8 might be raised.

This heating or temperature variation step might be used to overcome the common problem that occurs when the product is fired and that is caused by the evaporation of excessive quantities of residual liquid remaining inside it: this would be avoided by suitably heating the fluid in the element 8 in such a way as to dry the layer that is in contact with the wall of the element 8 itself.

Lastly, usually just before the step of opening the mould, there is a step of discharging from the cavity 4 all the slip 7 that is still in the liquid state.

A mould made in this way therefore achieves the above mentioned aims thanks to a simple, rational structure preventing the formation of defects on large parts cast in large cavities.

This is accomplished by the expandable element which makes it possible to reduce the volume of the forming cavity and “forces”, that is to say, drives the incoming liquid against the walls of the cavity and prevents it from extending over a large area: the volume in which the slip can spread is therefore reduced to a minimum.

In short, the liquid settles around the expanded element 8 and is driven by the element against the surfaces of the cavity without being allowed to grow slowly in a very large volume.

All this means greater certainty of producing high-quality sanitaryware, especially liquid cast sanitaryware, without significantly altering the structure of the mould.

It will be understood that the invention described may be useful in many industrial applications and may be modified and adapted in several ways without thereby departing from the scope of the inventive concept. Moreover, all the details of the invention may be substituted by technically equivalent elements.

1. A mould for making a ceramic product, the mould (1), of porous type, consisting of two half-parts (2, 3) joined to each other to create a product forming cavity (4); one of the half-parts (2) having a first inlet opening (5) through which respective means (6) feed a liquid (7) under pressure into the product forming cavity (4), wherein:
the cavity (4) defined by the at least two half-parts (2, 3) is closed, and wherein the mould (1) comprises:
at least one variable volume element (8) located inside the cavity (4) and connected to an inside surface (9) of one of the half-parts (3);
second means (10) for feeding a fluid under pressure, acting on the element (8) and varying the volume of the element (8) between at least two limit states, namely, a least expanded, idle state and a most expanded working state, creating a gap (M) between the surfaces of the cavity (4) and the element (8) itself, when the forming liquid (7) is fed in, and where the element (8) occupies a predetermined volume of the cavity (4) in such a way as to control the inflow of the liquid (7) along the surfaces of the cavity (4);
means (11) for controlling and regulating the degree to which the expandable element (8) is filled and the liquid (7) feed quantity/pressure, acting on the respective first feed means (6) and second feed means (10) in such a way as to correlate the feed pressures according to the extent to which the cavity (4) has been filled by the liquid (7).

2. The mould according to claim 1, wherein the ceramic product made is an article of sanitaryware.

3. The mould according to claim 1, wherein the second means (10) for feeding a fluid under pressure are connected to fluid supply means (10′) designed to cause the element (8) to be expanded.

4. The mould according to claim 1, wherein the element (8) possesses properties of elastic deformability.

5. The mould according to claim 1, wherein the element (8) is attached to a surface (9) of the half-part (3) defining a neutral area for the production of the product.

6. The mould according to claim 1, wherein the element (8) is attached to a surface (9) having a concavity designed at least to accommodate one end of the element (8).

7. The mould according to claim 6, wherein the concavity is defined by a curved portion (12).

8. The mould according to claim 1, wherein the half-part (3) of the mould (1) in which the expandable element (8) is fitted is equipped with a through duct (10), defining the second feed means, for feeding a fluid under pressure from outside the mould (1) and connected, at one end, to the element (8) and, at the other end, to fluid supply means (10′).

9. The mould according to claim 8, wherein the fluid supply means (10′) comprise means (14) for reversing the fluid flow in such a way as to enable the fluid to be either filled into the element (8) or sucked out of the element (8).

10. The mould according to claim 1, wherein the element (8) consists of a single body of elastically compliant material having at one end a fluid inlet opening associated in a sealed fashion with a support (15) by which it is connected to the surface (9) having a duct (10) for connection to means (10′) for supplying the fluid and designed to enable the element (8) to change from the idle state to the working state and vice versa.

11. The mould according to claim 1, wherein the element (8) consists of an external body of elastically compliant material and an internal body or frame (16) of rigid material designed to keep the external body (8) in a matching shape when it is in the idle state; the external body (8) having at one end a fluid inlet opening associated in a sealed fashion and in conjunction with the frame (16), with a support (15) by which it is connected to the surface (9) having a duct (10) for connection to means (10′) for supplying the fluid and designed to enable the element (8) to change from the idle state to the working state and vice versa.

12. The mould according to claim 11, wherein the body or internal frame (16) is made of a rigid, porous material.

13. The mould according to claim 1, wherein the element (8) consists of a single body of elastically compliant material having at one end a fluid inlet opening associated in a sealed fashion with a support (15) by which it is connected to the surface (9) with a duct (10) for connection to means (10′) for supplying the fluid and designed to enable the element (8) to change from the idle state to the working state and vice versa; the body (8) being positioned inside a second cavity (17) with an inside depth (P) such as to accommodate the body (8) in the least expanded state when the fluid supply means (10′) suck the fluid out of it in such a way as to completely free the forming cavity (4).

14. The mould according to claim 10, wherein the elastically compliant body (8) is made of natural elastic rubber.

15. The mould according to claim 10, wherein the elastically compliant body (8) is made of silicone material.

16. The mould according to claim 1, wherein the at least one forming cavity (4) has in it at least two separate elements (8, 8′) placed side by side.

17. The mould according to claim 10, wherein the fluid supply means (10′) are connected to a fluid source (18) controlled by control means (11) enabling the element (8) to be expanded, in the working state, to a pressure at least equal to the pressure at which the liquid (7) is fed into the forming cavity (4).

18. The mould according to claim 17, wherein the control means (11) act on the fluid supply means (10′) in such a way that the element (8) is expanded to a pressure greater than the pressure at which the liquid (7) is fed into the forming cavity (4).

19. The mould according to claim 1, wherein the fluid under pressure used for expanding is gaseous.

20. The mould according to claim 1, wherein the fluid under pressure used for expanding is liquid.

21. The mould according to claim, wherein the control means (11) act on the fluid supply means (10′) in such a way that the element (8), in the least expanded state, has a pressure inside it at least close to atmospheric pressure when the liquid (7) has filled the forming cavity (4) completely.

22. The mould according to claim 10, wherein the fluid supply means (10′) are connected to a fluid source (18) controlled by control means (11) enabling the element (8) to be expanded, in the working state, to a pressure equal to the pressure at which the liquid (7) is fed into the forming cavity (4), when the cavity (4) is filled and to the subsequent increased pressure of the liquid (7), thus creating a condition of equal pressure forming an internal elastic surface in contact with the liquid (7) and an auxiliary wall assisting the formation of the thickness of the ceramic product.

23. The mould according to claim 22, wherein the element (8) has means (18a) for varying the temperature of the fluid fed into the element (8).

24. The mould according to claims 22, wherein the control means (18a) are associated with the frame (16) and connected to the control means (11) in such a way as to enable the temperature of the fluid fed into the element (8) to be increased.

25. The mould according to claim 1, wherein the outside surface of the element (8) in the working state is in contact with the inside surfaces of the forming cavity (4).

26. The mould according to claim 1, wherein the control means (11) comprise a unit (19) for measuring and displaying the pressure values; the unit (19) being connected to the feed means (6) and to the second feed means (10) and being designed to turn the fluid flowing through the means (10) on or off or reverse its direction at least according to the pressure measured and a cavity filling time.

27. The mould according to claim 1, wherein the element (8) in the working state occupies a volume of the cavity (4) of at least between 50% and 100% of the total volume of the cavity (4) itself, thus forming the gap (M).

28. The mould according to claim 1, wherein the expandable element (8), when it is in the idle state or at rest, is cylindrical in shape.

29. The mould according to claim 1, wherein the supply means (10′) for feeding fluid into the element (8) comprise an adjustable relief valve unit (10v) connected to the control means (11).

30. A method for making a ceramic product using a porous mould (1) according to claim 1, the method comprising at least the following steps after the half-parts (2, 3) of the mould (1) have been closed:
filling a fluid into the element (8) until reaching the most expanded state of the element (8) itself inside the cavity (4) and at a predetermined pressure, thereby forming the gap (M);
feeding the liquid (7) in controlled manner along the surfaces of the cavity (4) at least in the gap (M) by filling the liquid (7) through the first inlet opening (5) in the half-part (2).

31. The method according to claim 30, wherein the liquid (7) is fed into the cavity (4) at a pressure that is less than the pressure inside the element (8).

32. The method according to claim 30, wherein the step of filling the gap (M) is followed by a step of feeding more liquid (7) into the cavity (4) and at the same time partially reducing the volume of the element (8) until the latter reaches its least expanded state.

33. The method according to claim 30, wherein the decrease in the pressure of the element (8) is controlled by the control means (11) acting on the second feed means (10) for supplying and discharging the fluid according to the quantity and pressure of the liquid (7).

34. The method according to claim 30, wherein the step of filling the gap (M) is followed by a step of feeding more liquid (7) and at the same time partially reducing the volume of the element (8) so as to allow a predetermined quantity of the liquid (7) to flow into the cavity (4) between the walls of the cavity (4) and the elastic surface of the element (8).

35. The method according to claim 34, wherein the step of filling a predetermined quantity of the liquid (7) into the cavity (4) is followed by a step of increasing the pressure of the element (8) at least until the pressure of the element (8) and the pressure of the liquid (7) inside the cavity (4) are equal.

36. The method according to claim 35, wherein the pressure of the element (8) is higher than the pressure of the liquid (7) at least for a predetermined length of time.

37. The method according to claim 35, further comprising a step of reducing the pressure and volume of the element (8) for predetermined lengths of time according to the formation of the product thickness (S) between the surfaces of the cavity (4) and an internal elastic surface formed by the element (8) and in contact with the liquid (7).

38. The method according to claim 35, wherein the steps of varying the pressure are controlled by the control means (11) acting on the second feed means (10) for supplying and discharging the fluid according to the presettable parameters.

39. The method according to claim 35, wherein the step of creating a condition of equal pressure is accompanied by a step of varying the temperature of the fluid fed into the element (8).

40. The method according to claim 39, wherein the step of varying the temperature is a step of increasing the temperature of the fluid.

41 The method according to claim 30, further comprising a step, following the formation of the product, of discharging from the cavity (4) all the slip (7) that is still in the liquid state.

42. The method according to claim 32, wherein the step of feeding more liquid (7) into the cavity (4) is performed at a pressure that is higher than the initial feed pressure.
